(19) United States
(12) Patent Application Publication
(10) Pub. No.: US 2003/0126247 A1
(43) Pub. Date: Jul. 3, 2003

(54) Apparatus and method for file backup using multiple backup devices

(75) Inventors: Amnon A. Strasser, Tel Aviv (IL); Nir Peleg, Be'er Ya'akov (IL); Robert Hofner, Ashdod (IL)

Correspondence Address: SUGHRUE MION, PLLC, 2100 PENNSYLVANIA AVENUE, N.W., WASHINGTON, DC, 20037, US

(73) Assignee: Exanet Ltd.

(21) Appl. No.: 10/033,166

(22) Filed: Jan. 2, 2002

(51) Int. Cl. G06F 15/173; G06F 17/30; G06F 12/00

(52) U.S. Cl. 709/223; 707/200

(57) ABSTRACT

A method and system are provided for file system backup using multiple backup devices in parallel. The system stores files across the backup devices, by first copying small files of sizes below a calculated threshold size, and then splitting into segments those files that are larger then the calculated threshold size. For each file segment, the system affixes a unique segment header. At restore time, a restore program starts the restore from the first file segment and follows to the next file segment according to information specified in the file segment header.

### BACKGROUND OF THE PRESENT INVENTION

1. Technical Field of the Present Invention

This invention generally relates to the field of computer data backup systems and, more specifically, to an improved computer data backup system particularly suited to the backup of data stored in large-scale computer systems using parallel backup techniques.

2. Description of the Related Art

There will now be provided a discussion of various topics to provide a proper foundation for understanding the present invention.

Computer files normally store data and other information on one or more nonvolatile storage devices, such as hard disks. Because devices that store computer files fail for a variety of reasons, computer files, critical or otherwise defined as backup worthy, are regularly copied or transferred to backup systems. In some cases, an entire data set is copied onto a backup system. In other instances, only incremental changes to previously stored information are sent to the backup system, i.e., an incremental backup. In other instances, a snapshot of the status of the system is sent to the backup system, thereby allowing restoration from that point onwards. In yet other instances log files are kept that detail changes made between the last backup process and the current backup process. When restoration is required the original data is sought and then the list of log files describing changes is used to update the data in the original file to upgrade its current data status. In general, computer files are backed up by copying the files to a different non-volatile storage device, such as a hard disk, a tape or even another computer system. This further provides the ability to save a snapshot of the status of a system at a given point in time. Typically, for backup purposes, removable media is used such that once the backup media is filled, it is replaced by empty removable media.

There are many fast and reliable techniques to store backup copies of files onto removable media, with tapes being most commonly used media. However, other media, such as removable data cartridges, are used as well. A conventional technique allows the user to specify multiple backup drives to be used serially. All the backup data is directed to a single output device as a stream of data in a sequence that reflects the order of objects to be saved. The objects can be files, directories or other data stored by the system. When one backup media is filled to capacity, or otherwise cannot contain the next to be stored object, the backup operation continues with the next backup device, while the first backup media on the first backup device is removed and stored for future use. The first backup device is loaded with fresh backup media, and once the second backup media is filled, the process can continue on the newly loaded backup media of the first backup device. Due to its serial nature, backup time will be a linear function of the total size of the collection of objects to be saved.

Faster backup is realized when using a plurality of backup devices operating in parallel. For example, consider a multi-volume file system having volumes A and B, wherein volume A contains files 1 through N and volume B contains files 1 through M. The backup routine may concurrently copy files 1 through N from volume A and files 1 through M from volume B to backup device 1 and backup device 2, respectively. While this method provides for faster backup, it does not provide good performance when one volume is significantly larger than the other volume. In this case, one backup device will be idle while the other backup device continues to backup the much larger volume.

A further technique for performing backup using multiple backup devices in parallel is a striping technique. The use of striping allows N backup devices to be used in parallel to create an N-way striped backup. In other words, files or blocks of data are written concurrently to the N backup devices by sending each file or block to one of the available backup devices. Such a technique reduces backup time by a factor proportional to N. In order to achieve good performance, however, the process should balance the workload such that all backup devices are kept busy and finish at approximately the same time.

The striping technique increases the possibility for system failure in both the storing and restoring processes. In order to perform a successful restore, all of the backup devices must function properly. Therefore, if a failure occurs during a store process or a restore process, even in a single backup media of a backup data set, the entire set becomes non-usable. When restoring data, another problem may arise if the system undergoing restoration is configured differently from the original backup system configuration. In these cases, significant effort will be required to coordinate the mounting and loading of data from the backup data set due to the incompatibility of the systems.

Backup systems usually assign a single storage device to one or more backup devices. Therefore, data from one storage device is not shared with the backup devices connected to other storage devices. For example, consider a system comprising four storage devices, each having bandwidth of 50 MB/sec and different capacity requirements, e.g., 5 terabytes (TB), 10 TB, 15 TB and 20 TB respectively. The system further comprises four backup devices for backup and restoration purposes, each with bandwidth of 50 MB/sec. In a typical implementation, a single storage device is assigned to a single backup device in order to ensure the bandwidth requirements. However, the above configuration requires the transfer of different sizes of data from each of the storage devices to their respective backup devices. The end result is the backup device that is backing up 5 TB finishes the backup process long before the backup device responsible for the backup of 20 TB will finish the backup process. At a rate of 50 MB/sec, the backup of 20 TB of data will require approximately 111 hours to complete [20 TB/(50 MB/sec)].

It would be advantageous to have a method and a system that can provide a flexible parallel backup that can use all the theoretically available system resources, such as bandwidth and resources. It would be further advantageous if the system could support the incremental and snapshot backup techniques.

### SUMMARY OF THE PRESENT INVENTION

The present invention has been made in view of the above circumstances and to overcome the above problems and limitations of the prior art.

Additional aspects and advantages of the present invention will be set forth in part in the description that follows and in part will be obvious from the description, or may be learned by practice of the present invention. The aspects and advantages of the present invention may be realized and attained by means of the instrumentalities and combinations particularly pointed out in the appended claims.

A first aspect of the present invention provides a computer network backup system comprising at least two backup devices, and at least one file source. The computer network backup system further comprises a control unit having a control program that directs files from the file source to the backup devices. The control program splits files stored on the file source into file segments, thereby equalizing the archival load between the backup devices. The computer network backup system further comprises a communications link coupled between the backup devices, the file source and the control unit.

A second aspect of the present invention provides method for file backup using a parallel backup system comprising at least one file source and at least two backup devices. The method comprises calculating a segmentation threshold value, and subsequent to calculating the segmentation threshold value, directing the files from the file source to the backup devices. The method further comprises splitting files that exceed the segmentation threshold value into file segments, wherein each of the file segments does not exceed the segmentation threshold value. The files located in said file source and the file segments are sorted into a lost, and the files smaller than the segmentation threshold value and the file segments are written to the backup devices according to the sorted list. Alternatively, the method further comprises sorting the files located in the file source into a sorted list, and writing files smaller than the segmentation threshold value into the backup devices according to the sorted list. Next, files that are larger than the segmentation threshold value are split into file segments according to space remaining in each of the backup devices, and then the file segments are written to the backup devices.

A third aspect of the present invention provides a computer software product for a parallel backup system comprising a file source and at least two backup devices. The computer program product comprises software instructions that enable the parallel backup system to perform predetermined operations, and a computer readable medium bearing the software instructions. The predetermined operations comprise calculating a segmentation threshold value, and subsequent to calculating the segmentation threshold value, directing the files from the file source to the backup devices. The predetermined operations further comprise splitting files that exceed the segmentation threshold value into file segments, wherein each of the file segments does not exceed the segmentation threshold value. The files located in said file source and the file segments are sorted into a lost, and the files smaller than the segmentation threshold value and the file segments are written to the backup devices according to the sorted list. Alternatively, the predetermined operations further comprise sorting the files located in the file source into a sorted list, and writing files smaller than the segmentation threshold value into the backup devices according to the sorted list. Next, files that are larger than the segmentation threshold value are split into file segments according to space remaining in each of the backup devices, and then the file segments are written to the backup devices.

A fourth aspect of the invention provides a computer system adapted for parallel backup of a file source and at least two backup devices. The computer system comprises a file source and at least two backup devices interconnected by a communications link. The computer further comprises a memory comprising software instructions adapted to enable the computer system to calculate a segmentation threshold value and direct files from the file source to the backup devices. The software instructions further comprise splitting files that exceed the segmentation threshold value into file segments, wherein each of the file segments does not exceed the segmentation threshold value. The files located in said file source and the file segments are sorted into a lost, and the files smaller than the segmentation threshold value and the file segments are written to the backup devices according to the sorted list. Alternatively, the software instructions further comprise sorting the files located in the file source into a sorted list, and writing files smaller than the segmentation threshold value into the backup devices according to the sorted list. Next, files that are larger than the segmentation threshold value are split into file segments according to space remaining in each of the backup devices, and then the file segments are written to the backup devices.

A fifth aspect of the present invention provides a method for calculating a size threshold in a parallel backup system comprising a file source and at least two backup devices. The method comprises summing the sizes of all files in the file source; and dividing the result by the number of available backup devices to arrive at the size threshold.

The above aspects and advantages of the present invention will become apparent from the following detailed description and with reference to the accompanying drawing figures.

### BRIEF DESCRIPTION OF THE DRAWINGS

The accompanying drawings, which are incorporated in and constitute a part of this specification, illustrate the present invention and, together with the written description, serve to explain the aspects, advantages and principles of the present invention. In the drawings,

FIGS. 1A and 1B are schematic diagrams of parallel backup systems;

FIG. 2 is an exemplary embodiment of a first file-spread algorithm according to the present invention;

FIGS. 3A to 3C are exemplary diagrams showing data packing on backup media according the first file-spread algorithm;

FIG. 4 is an exemplary embodiment of a second file-spread algorithm according to the present invention;

FIGS. 5A to 5B are exemplary diagrams showing data packing on backup media according the second file-spread algorithm; and

FIG. 6 is a schematic of a typical computer cluster capable of embodying the present invention;

### DETAILED DESCRIPTION OF THE INVENTION

Prior to describing the aspects of the present invention, some details concerning the prior art will be provided to facilitate the reader's understanding of the present invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

As used herein, the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but is not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone link, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer-readable medium, as defined above, which bears instructions for performing predetermined operations in any form.

As used herein, the term “network switch” includes, but is not limited to, hubs, routers, ATM switches, multiplexers, communications hubs, bridge routers, repeater hubs, ATM routers, ISDN switches, workgroup switches, Ethernet switches, ATM/fast Ethernet switches and CDDI/FDDI concentrators, Fiber Channel switches and hubs, InfiniBand switches and routers.

As used herein, the term “computer file” or “file” includes, but is not limited to, files stored in a computer's memory, such files may include data, programs, logs, or other types of information used in a computer environment. Furthermore, the term shall include data fathered as snapshots of a computer system status, as well as data gathered for the purpose of incremental backup.

A detailed description of the aspects of the present invention will now be given referring to the accompanying drawings.

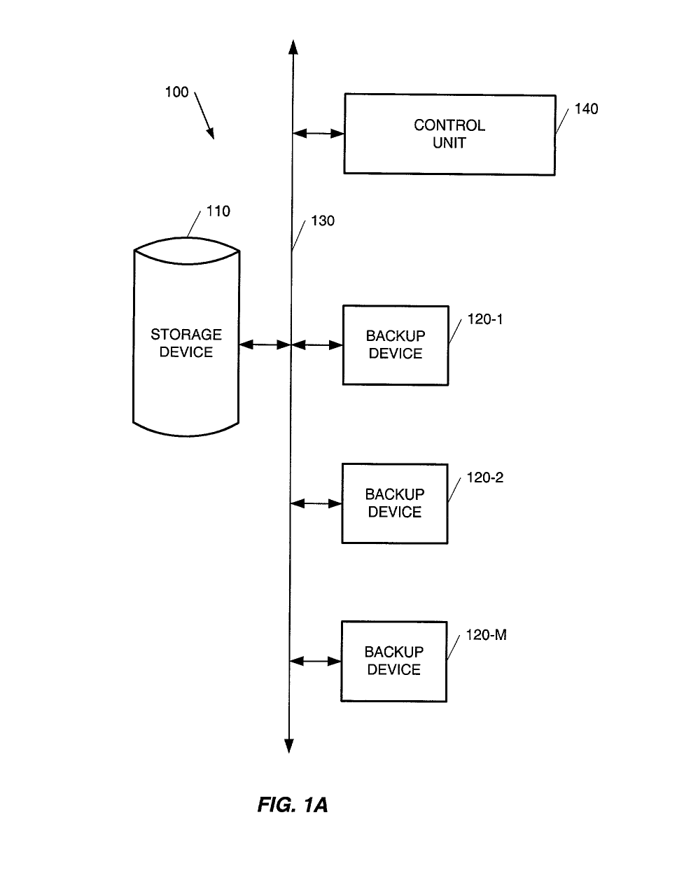

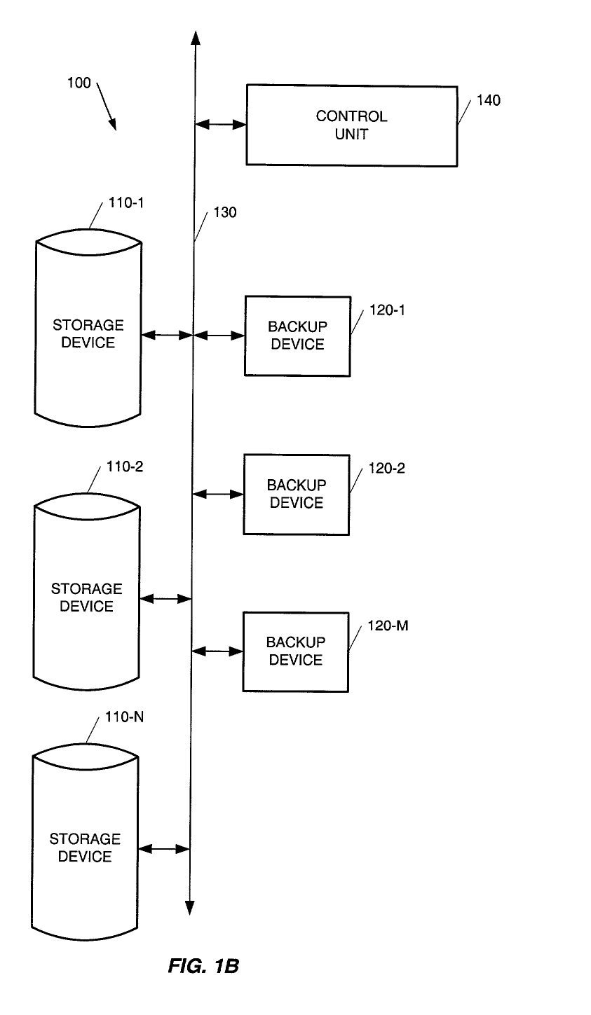

Referring to FIG. 1A, an exemplary parallel backup system 100 is illustrated. The system 100 comprises a storage unit 110 and backup devices 120-1 to 120-M, where M is the number of backup devices. Storage units may comprise, but are not limited to, hard disks, random access memory (RAM), programmable non-volatile memory, a redundant array of independent disks (RAID), a file system, a distributed file system, location independent file system, magnetic disks and other mass storage devices. Backup devices may comprise, but are not limited to, tape devices, compact disk read only memory (CD-ROM), compact disk read-write (CD-RW), digital video disk (DVD), magnetic disks, non-volatile random access memory (NVRAM), and other devices capable of permanent mass backup storage. Typically, the storage unit 110 will contain files in a variety of sizes.

Each of the tape devices 120-1, 120-2, 120-M is connected to a storage unit 110 through a common communications link 130. In general, the common communications link 130 is designed to be a high bandwidth communications link that allows for the parallel addressing of multiple devices, e.g., a local area network (LAN), a wide area network (WAN), a peripheral component interconnect (PCI) network or an InfiniBand network. In addition, various protocols, such as Ethernet, Internet Protocol (IP), File Transfer Protocol (FTP), and Asynchronous Transfer Mode (ATM) can be used as well. A computer program, or otherwise a suitable embedded control mechanism, resident in control unit 140, is responsible for controlling the backup process.

Generally, the parallel backup process executes as follows. First, a segmentation threshold (ST) is determined as the sum of the sizes of all files on the storage device 110 divided by the number of backup devices 120-1, 120-2, 120-M. Files having a size smaller than the segmentation threshold are copied to backup devices 120-1, 120-2, 120-M first. The backup devices to which such files are written are selected based on a least filled-up backup device algorithm. This means that the next file to be written to a backup device will be directed to that backup device to which the least amount of data was targeted to at a given moment in time. If there are several candidates, selection algorithms, such as random, round robin or weighted round robin, may be used.

One exemplary embodiment of the present invention is described below as a file-spread algorithm (FSA). Files that are greater in size than the segmentation threshold are handled after the smaller files have been copied to the backup devices 120-1, 120-2, 120-M. These large files are split into segments and subsequently directed, segment by segment, to the then least filled-up backup device for backup purposes.

Referring to FIG. 1B, a further enhancement of the system 100 is shown. In this case, multiple storage devices 110-1, 110-2, 110-N, where N represents the number of storage devices, are connected by a common communication means 130 to multiple backup devices 120-1, 120-2, 120-M. The backup process may operate under the assumption that the entire storage system is an aggregation of the storage devices 110-1 to 110-N. In this case, the operation of the system will generally resemble the operation of the system described above, i.e., the total amount of data is divided by the number of backup devices M to establish a segmentation threshold value. The control unit 140 will operate as described above, i.e. storing files on the backup media where the file source may be one of the storage devices 110-1 to 110-N. Alternatively, the computer program of the control unit 140 can allocate the backup devices 120-1 to 120-M to a storage device 110-1 to 110-N in accordance with one or more parameters, such as the amount of data on a storage device 110, the type of files stored on a storage device 110 (e.g., database files, JPEG, etc.), the type of backup devices 120, and the speed of backup devices 120. This list is not limited in any way, and does not exclude of other parameters that could be used to determine allocation of files from a storage device 110 to a backup device 120.

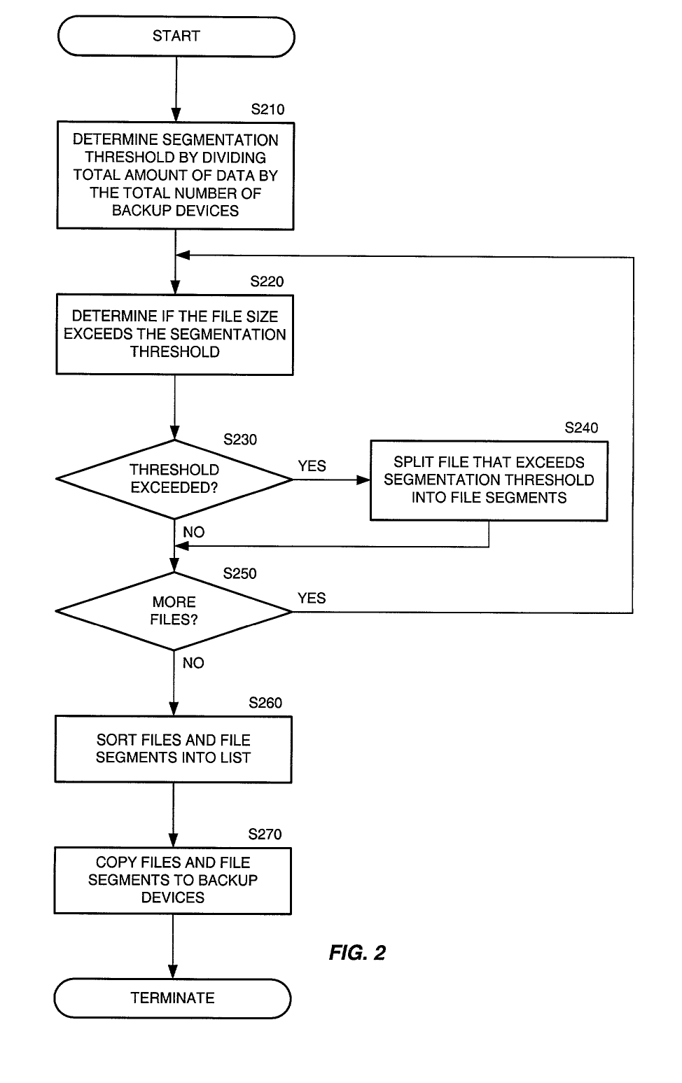

Referring to FIG. 2, an exemplary embodiment of a first file-spread algorithm (FSA) is shown. The first file-spread algorithm allocates files to backup devices according to the size of each file. The first file-spread algorithm balances between efficiency, i.e., the time it takes to build a file-spread scheme, and quality, i.e., the deviation in data amounts sent to each of the backup devices.

At S210, the segmentation threshold (ST) is determined. The segmentation threshold is equal to the total amount of data stored on a storage device (or storage devices) divided by the total number of backup devices. As described above, backup devices may comprise, but are not limited to, tape devices, compact disk read only memory (CD-ROM), compact disk read-write (CD-RW), digital video disk (DVD), magnetic disks, non-volatile random access memory (NVRAM), and other devices capable of permanent mass backup storage.

At S220, a determination is made as to which files exceed the segmentation threshold. The size of each file that is to be backed up is compared to the segmentation threshold. If the file size exceeds the segmentation threshold, then, at S240, the file is split into segments. The size of the file segments is no greater than the segmentation threshold, which was previously calculated. If the file is smaller than the segmentation threshold, then the process continues on to S250.

At S250, a determination is made if there are more files to compare against the segmentation threshold. If there are more files to compare against the segmentation threshold, then the process returns to S220 and compares the next file. If all the files that are to be backed up have been compared to the segmentation threshold, then the process continues to S260.

At S260, the file segments and those files that are smaller than the segmentation threshold are sorted into a list. The list is sorted by file size, with the largest files and/or largest segments at the beginning of the list. Alternatively, the list can be sorted such that the largest files and/or largest segments are placed at the end of the list. At S270, each file and/or file segment is copied to a backup device that has the least filled-up media. Files and/or file segments are copied concurrently according to their position in the sorted list using the entire possible bandwidth of the common communications link. A person skilled in the art could easily implement a file-spread algorithm using other sort procedures as well. Furthermore, a person skilled in the art could use the method described above for the purpose of backup where the data is the information relative to the changes made in the system between the previous and the current backup process, i.e. an incremental backup. Similarly a person skilled in the art could use this method for the purpose of backup of a system snapshot, i.e. the data for backup contains system information and status.

When a restore process is executed, the number of backup devices 120 required for the restore process will be relatively low. This is due to the fact that most of the files that are below the segmentation threshold are stored on a single backup device media. Additionally, the restore process is more reliable in comparison to previously used solutions because the first file-spread algorithm reduces the number of points of failure that can affect a single file.

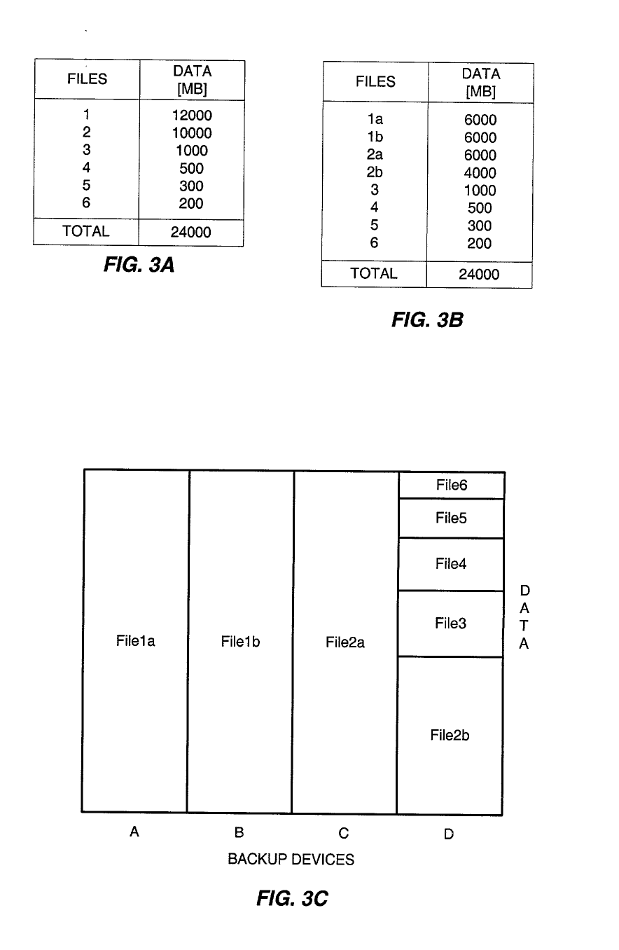

Referring to FIGS. 3A-3C, an example of a file backup using the first file-spread algorithm (described in FIG. 2) is shown. In the example, six files are to be backed up, and the sum of the file sizes is equal to twenty-four megabytes. The detailed sizes of the files are shown in FIG. 3A. Referring to FIG. 3C, there are four available backup devices marked “A” through “D” in the exemplary backup system.

According to first file-spread algorithm, the following process is performed. First, the segmentation threshold is calculated. Since the total amount of data to be backed up is 24 megabytes and there are four backup devices, the segmentation threshold is 6 megabytes. Next, any file that exceeds the segmentation threshold of 6 megabytes is split into file segments. FIG. 3A illustrates the file sizes of the six files to be backed up, and File1 and File2 will be split into file segments, since both files exceed the 6 megabyte segmentation threshold. File1 is split into two file segments of 6 megabytes each. File2 is split into two file segments, one 6 megabyte segment and one 4 megabyte segment. File2 could also have been split into two 5 megabyte segments as well, as those file segments would be less than the segmentation threshold, however, such partitions may result in certain inefficiencies in backup memory usage.

After File1 and File2 have been segmented, both the small files and file segments are sorted into a list in descending order based on size. FIG. 3B illustrates the sorted list of files and file segments. It can be clearly seen that File1 is now split into two file segments File1a and File1b each of the size of 6 megabytes (together comprising the full File1 of 12 megabytes). Likewise, File2 is now split into two file segments File2a and File2b (together comprising the full File2 of 10 megabytes).

Referring to FIG. 3C, the fill-in process of backup devices is shown. Files and/or file segments are directed to the backup devices by size order. Therefore, the file segment File1a will be directed to backup device “A”. Parallel to the operation of backup device “A”, the file segment File1b is sent to backup device “B”, since it is the next in line to be backed-up. Still in parallel, the file segment File2a will be directed to the next available backup device, which is backup device “C”. The remaining file segment File2b and File3 through File6 will be directed to the backup device “D”. All four backup devices are now operating in parallel, and each device is backing up 6 megabytes of data.

It is clear from FIG. 3C that, if a failure occurs in one of the backup devices, File 1 through File6 are not all affected. For example, if failure occurs in backup device “B”, only a single file is affected, namely File1. This is a clear advantage over the damage that would occur to all six files when using data striping or other techniques. Moreover, if it is necessary to restore only a single file, there is no need for using all backup devices. For example, if File4 is to be restored, only the backup media used in backup device “D” needs to be loaded on the restoring system. It should be noted that copying files to different backup media does not require synchronization between the backup devices. Hence, in order to write File3 to the backup device “D”, there is no need to wait until backup device “C” finishes writing.

An additional feature of the present invention is the ability to handle failure in one or more backup devices. For example, a backup device fails at some point in time after the beginning of the backup process. While some of the data has been backed up, the remainder of the data still needs to be stored on the remaining operative backup devices. Therefore, the first file-spread algorithm will redirect the files and/or file segments, not copied in full onto the failed backup device, to the other the remaining operative backup devices. The redirection will take place such that the load will be spread equally among the remaining operative backup devices. Alternatively, upon detection of failure of a backup device, the first file-spread algorithm redirects the entire content originally targeted for the failed backup device to the remaining operative backup devices.

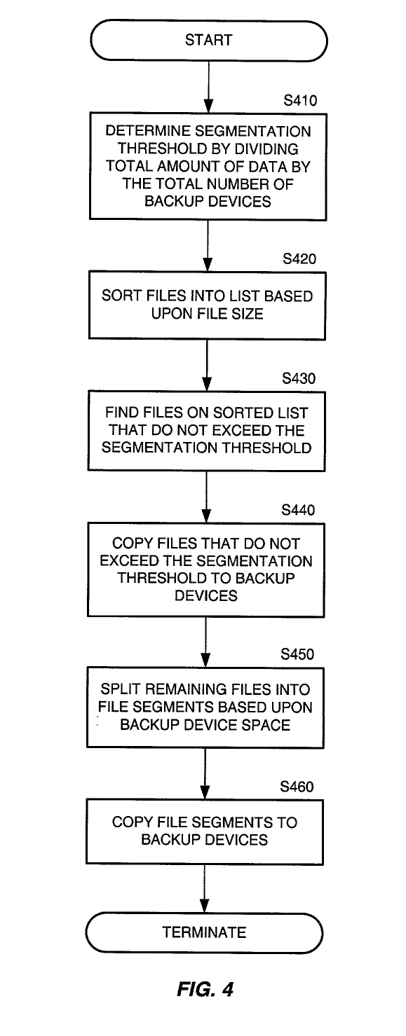

Referring to FIG. 4, an exemplary embodiment of a second file-spread algorithm is illustrated. In the second file-spread algorithm, files that are below the segmentation threshold are first directed to the backup devices, and then the file segments from files that were above the segmentation threshold are directed to the backup devices.

At S410, the segmentation threshold (ST) is determined. The segmentation threshold is equal to the total amount of data stored on a storage device divided by the total number of backup devices. As described above, backup devices may comprise, but are not limited to, tape devices, compact disk read only memory (CD-ROM), compact disk read-write (CD-RW), digital video disk (DVD), magnetic disks, non-volatile random access memory (NVRAM), and other devices capable of permanent mass backup storage.

At S420, the sizes of the files stored on the storage device (or storage devices) are sorted into a list. The list is sorted by file size, with the largest files at the beginning of the list. At S430, a determination is made as to which files exceed the segmentation threshold. Simply reviewing the sorted list can make this determination, and locating the first file in the list that is equal to or below the segmentation threshold. Since the files in the list are sorted in descending order, after the first file below the segmentation threshold is located, all the files listed after it will necessarily be equal to or below the segmentation threshold. Alternatively, the files can be sorted in ascending order, with the largest files at the end of the list. Thus, after the first file in the list that exceeds the segmentation threshold is located, all files that precede that file are necessarily below the segmentation threshold. At S440, all the listed files (inclusive of the first file found to be equal to or below the segmentation threshold) are copied to the least filled up backup device.

At S450, since the remaining files on the list will exceed the segmentation threshold, these files are split into file segments. The file segment sizes are targeted to fit space that is available in each of the backup devices. At S460, the file segments are copied to the backup devices.

When a restore process is executed for files that were saved using the second file-spread algorithm, the number of backup media required for restore process may be usually higher then when the first file-spread algorithm is used. This occurs because the number of file segments is generally higher. However, the restore process will be faster due the higher degree of parallelism.

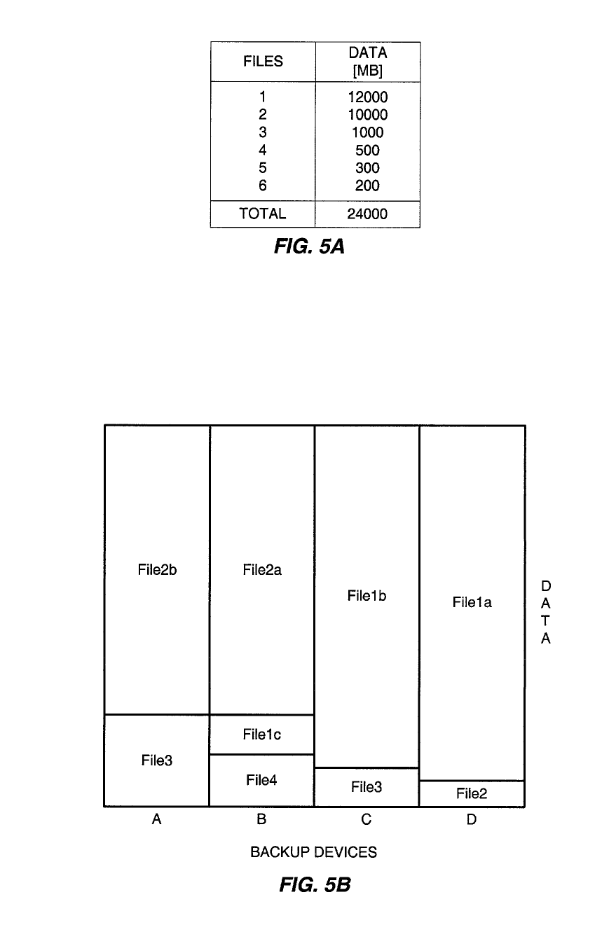

Referring to FIGS. 5A and 5B, an example of a file backup using the second file-spread algorithm (described in FIG. 4) is shown. In the example, six files are to be backed up with a total amount of data equal to twenty-four megabytes. The file sizes are shown in FIG. 5A. There are four available backup devices marked “A” through “D” in the exemplary backup system.

According to the second file-spread algorithm, the following process is performed. First, the segmentation threshold is calculated. Since the total amount of data to be backed up is 24 megabytes and there are four backup devices, the segmentation threshold is 6 megabytes. Next, the files are sorted into a list in descending order based on file size; the results are shown in FIG. 5A.

Referring to FIG. 5B, the fill-in process of the backup devices is shown. Initially, the second file-spread algorithm fills up the backup media with files equal to or below the segmentation threshold, i.e., those files that are 6 megabytes or smaller. The first file smaller than the segmentation threshold is File3, which is directed to backup device “A”. Next, File4 is directed to the next backup device, specifically backup device “B”. In a similar fashion, File5 and File6 are directed to backup devices “C” and “D”, respectively. It should be noted that in this case a round-robin mechanism is used for backup devices having an equal amount of free storage space. However, other backup device selection algorithms may be used such as random or weighted round robin.

The files that exceed the segmentation threshold are split into file segments that fit the available space on the backup devices. File1, which is 12 megabytes in size, is split into segments according to the space remaining on backup devices. Since the second file-spread algorithm fills up backup devices starting with the least filled up backup device, the next backup device to be used is backup device “D” having 5.8 megabytes available for file segment File1a of File1. The remaining 6.2 megabytes of File1 are further segmented as the next least loaded backup device is “C” having a total available space of 5.7 megabytes which are used for file segment File1b of File1. The remaining 500 kilobytes, which are now file segment File1c of File1 are copied to backup device “B” the next least loaded backup device. Similarly, File2 is segmented into two file segments File2a and File2b, each of the size of 5 megabytes and backed up onto backup devices “B” and “A”, respectively. It is important to note that the amount of data backed up to each backup device is based on the total amount of data to be backed up divided by the number of backup devices, i.e., the segmentation threshold. The data capacity of the backup medium does not affect the amount of data that is backed up to a particular backup device.

From FIG. 5B, it should be apparent that, if a failure occurs in one of the backup devices, not all of the files are affected. For example, if failure occurs in backup device “B”, only three files are affected, as opposed to six files when using data striping techniques. Moreover, when restoring a small file it is not necessary to use all the backup devices. It should be noted that copying files to different backup media does not require synchronization between backup devices.

An additional feature of the present invention is the ability to handle failure in one or more backup devices. For example, a backup device fails at some point in time after the beginning of the backup process. While some of the data has been backed up, the remainder of the data still needs to be stored on the remaining operative backup devices. Thus, the second file-spread algorithm will redirect the files and file segments that were not copied in full onto the failed backup device to the other remaining operative backup devices. The redirection is such that the load will be spread equally among the remaining operative backup devices. Alternatively, upon detection of failure of a backup device, the second file-spread algorithm redirects the entire content originally targeted for the failed backup device to the remaining operative backup devices.

For both the first file-spread algorithm and the second file-spread algorithm, it is advantageous to add a file header to each file segment when splitting a file to file segments. A file header is part of a file that precedes the actual data. A file header usually comprises file attributes such as, file identification, file size, offset information, file permissions, or other relevant information. Offset information indicates a position within the file. Both offset and file size may be specified in bytes, blocks or other units of measurement that the system may use. The information in file header is arranged in fields, i.e., file size field, offset field, etc.

When splitting a file into file segments, a file header is affixed to each file segment. Some information in the affixed file header may be manipulated in order to be consistent with the file segment attributes. Specifically, the file size field in affixed file header should refer to the total size of a file segment. Otherwise, the file size field in a file segment should be set to the segmentation threshold. In order to restore files, a restore program should seek the first segment of a file, i.e., the file segment with an offset equal to zero. Similarly, a header will be attached to data respective of incremental backup process, or to snapshot data. This will make such data readily available and locatable when restore is necessary.

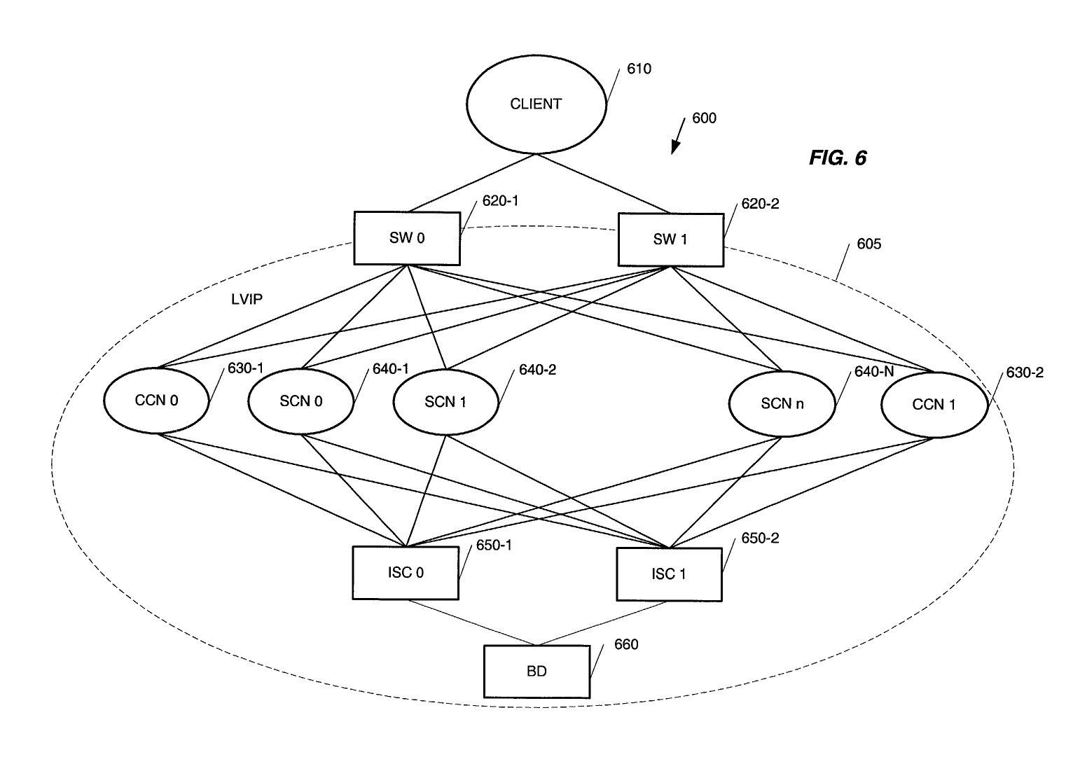

Referring to FIG. 6, a parallel and distributed backup system is illustrated. A detailed description of the architecture is included in PCT application number PCT/US00/34258, entitled “Interconnect Topology For A Scalable Distributed Computer System,” which is assigned to the same common assignee as the present application, and is hereby incorporated herein by reference in its entirety for all it discloses.

System 600 is a distributed storage cluster, in such a cluster 605 there may be at least two network switches (SW) 620 allowing for at least two communication paths to a client 610. Each SW 620 is connected to multiple storage control nodes (SCN) 640 and to at least two cache control nodes (CCN) 630. At least two interconnect switches (ICS) 650 are connected to SCNs 640 and CCNs 630 to allow for redundant means of communication between the different elements. System 600 also comprises backup devices (BD) 660 connected to at least two ICS 650 to allow backup traffic, regardless the available bandwidth.

In accordance with one aspect of this invention, storage objects are stripped across multiple nodes and backup devices are accessible to all nodes in storage cluster. Moreover, backup devices are not longer dedicated to a specific storage device, and, therefore data can be efficiently shared. The artisan could easily add as many backup devices as desired and distribute backup traffic evenly among them, regardless of file system size or location.

For example, assume that the system 600 has a total amount of data requiring backup is 50 terabytes. Furthermore, the number of backup devices is four and the bandwidth is 50 megabytes/sec. Sharing data between backup devices and storage devices reduces the total time required for full backup. As shown in Equation (1), the total backup time is calculated by dividing the total amount of data to be stored by the multiplication of the available bandwidth and the number of backup devices.

TotalNumBytes/Bandwidth*NumBackupDevices=TotalBackupTime Equation (1)

Therefore, with TotalNumBytes=50 terabytes, Bandwidth=50 megabytes/sec, and NumBackupDevices=4, the TotalBackupTime is approximately 69 hours, an almost 38% reduction in backup time in comparison with the approximately 111 hours shown in the background example. Clearly, adding additional backup devices will result in a decrease in the total time required for data backup.

Another aspect of the present invention provides a computer software product for a parallel backup system that comprises a file source and at least two backup devices. The computer program product comprises software instructions that enable the parallel backup system to perform a series of predetermined operations. The computer program product further comprises a computer readable medium that bears the software instructions. When performing a backup operation, the predetermined operations calculate a segmentation threshold value, and, after calculating the segmentation threshold, the predetermined operation cause the parallel backup system to direct files from the file source to the backup devices. The predetermined operations calculate the segmentation threshold value by summing the sizes of all the files in stored in the file source and dividing the result by the number of backup devices that will be used to backup the files.

During the backup process, the predetermined operations split files that exceed the segmentation threshold value into file segments, such that each of the file segments does not exceed the segmentation threshold value. The predetermined operations will sort the remaining files located in file source and the file segments into a sorted list. The files and file segments can be sorted in ascending or descending order. The predetermined operations will then cause the parallel backup system to write files that are smaller than the segmentation threshold value and the file segments to the backup devices according to their position on the sorted list. Alternatively, the write operation can proceed concurrently, i.e., file segments and whole files written concurrently to the backup devices. Prior to writing the file segments to the backup devices, the predetermined operations attach a header to each of the file segments. The file segment header comprises an offset field and/or a size field. Finally, during the backup process, the predetermined operations may route the files and file segments being backed up to the then least filled-up backup device. This technique spreads the workload amongst the backup devices, and speeds up the backup process.

Alternatively, the predetermined operations on the computer program product can cause the parallel backup system to sort the files stored on the file source into a sorted list prior to any files undergoing segmentation because they exceed the segmentation threshold value. The predetermined operations will sort the files located in the file source into a sorted list. Again, this list can be in ascending or descending order, depending upon file size. The predetermined operations will cause files that are smaller than the segmentation threshold value to be written to the backup devices according to the sorted list. After the transfer of the smaller files has completed, the predetermined operations cause the files larger than the segmentation threshold value to be split into file segments according to space remaining in each of the backup devices. After the file segmentation is complete, the predetermined operations cause the file segments to be written to the backup devices.

Another aspect of the present invention provides a computer system adapted for parallel backup of a file source and at least two backup devices. The computer system comprises a file source and at least two backup devices interconnected by a communications link. The computer system further comprises a memory having software instructions adapted to enable the computer system to perform various operations. The software instructions enable the computer system to calculate a segmentation threshold value, and subsequent to the calculation of the segmentation threshold value, the software instructions cause the computer system to direct the files from the file source to the backup devices. When performing a backup operation, the software instructions enable the computer system calculate a segmentation threshold value, and, after calculating the segmentation threshold, the software instructions command the computer system to direct files from the file source to the backup devices. The computer system calculates the segmentation threshold value by summing the sizes of all the files in stored in the file source and dividing the result by the number of backup devices that will be used to backup the files.

During the backup process, the software instructions cause the computer system to split files that exceed the segmentation threshold value into file segments, such that each of the file segments does not exceed the segmentation threshold value. The computer system will sort the remaining files located in file source and the file segments into a sorted list. The files and file segments can be sorted in ascending or descending order. The software instructions will then enable the computer system to write files that are smaller than the segmentation threshold value and the file segments to the backup devices according to their position on the sorted list. Alternatively, the write operation can proceed concurrently, i.e., file segments and whole files written concurrently to the backup devices. Prior to writing the file segments to the backup devices, the computer system attaches a header to each of the file segments. The file segment header comprises an offset field and/or a size field. Finally, during the backup process, the software instructions enable the computer system to route the files and file segments being backed up to the then least filled-up backup device. This technique spreads the workload amongst the backup devices, and speeds up the backup process.

Alternatively, the software instructions enable the computer system to sort the files stored on the file source into a sorted list prior to any files undergoing segmentation because they exceed the segmentation threshold value. The computer system will sort the files located in the file source into a sorted list. Again, this list can be in ascending or descending order, depending upon file size. The software instructions enable the computer system to write files that are smaller than the segmentation threshold value to the backup devices according to the sorted list. After the transfer of the smaller files has completed, the software instructions command the computer system to split files larger than the segmentation threshold value into file segments according to space remaining in each of the backup devices. After the file segmentation is complete, the computer system writes the file segments to the backup devices.

The foregoing description of the aspects of the present invention has been presented for purposes of illustration and description. It is not intended to be exhaustive or to limit the present invention to the precise form disclosed, and modifications and variations are possible in light of the above teachings or may be acquired from practice of the present invention. The principles of the present invention and its practical application were described in order to explain the to enable one skilled in the art to utilize the present invention in various embodiments and with various modifications as are suited to the particular use contemplated.

Thus, while only certain aspects of the present invention have been specifically described herein, it will be apparent that numerous modifications may be made thereto without departing from the spirit and scope of the present invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A computer network backup system comprising:
at least two backup devices;
at least one file source;
a control unit comprising a control program that directs files from said file source to said backup devices, wherein said control program splits files into file segments, thereby equalizing the archival load between said backup devices;
a communications link coupled between said backup devices, said file source and said control unit.

2. The system of claim 1, wherein said backup device a hard disk, an optical disk, a magnetic tape drive or a non-volatile random access memory.

3. The system of claim 1, wherein said backup devices are geographically distributed.

4. The system of claim 1, wherein said file source is a storage device, a hard disk, a random access memory, a programmable non-volatile memory, a redundant array of independent disks (RAID), incremental backup data, snapshot data, a file system, a distributed file system or a location independent file system.

5. The system of claim 1, wherein said file source is comprised of at least two independent file sources.

6. The system of claim 1, wherein said communications link is a local area network (LAN), a wide area network (WAN), a peripheral component interconnect (PCI) or an InfiniBand.

7. The system of claim 1, wherein the protocol of said communications link is Ethernet, Internet protocol (IP) or asynchronous transfer mode (ATM).

8. The system of claim 1, wherein said control program calculates a file size segmentation threshold value.

9. The system of claim 8, wherein said segmentation threshold value is calculated by summing the sizes of all files in said file source and dividing the result by the number of said backup devices.

10. The system of claim 8, wherein said control program:
splits files that exceed said segmentation threshold value into file segments, wherein each of said file segments does not exceed said segmentation threshold value;
sorts files located in said file source and said file segments into a sorted list; and
writes files smaller than said segmentation threshold value and said file segments into said backup devices according to said sorted list.

11. The system of claim 10, wherein said files and said file segments are sorted in descending order based upon file size.

12. The method of claim 10, wherein said files and said file segments are sorted in ascending order based upon file size.

13. The system of claim 1, wherein said control program receives notification of backup device failure.

14. The system of claim 13, wherein said control program redirects said files and said file segments not already backed up on said failed backup device to at least one operative backup device.

15. The system of claim 14, wherein said control program balances the load between the remaining operative backup devices.

16. The system of claim 10, wherein said control program writes said files and said file segments to the then least filled-up backup device.

17. The system of claim 10, wherein said control program attaches a header to each of said file segments.

18. The system of claim 17, wherein said file segment header comprises at least one of an offset field or a size field.

19. The system of claim 8, wherein control program:
sorts files located in said file source into a sorted list;
writes files smaller than said segmentation threshold value into said backup devices according to said sorted list;
splits files larger than said segmentation threshold value into file segments according to space remaining in each of said backup devices; and
writes said file segments onto said backup devices.

20. The system of claim 19, wherein said files and said file segments are sorted in descending order based upon file size.

21. The system of claim 19, wherein said files and said file segments are sorted in ascending order based upon file size.

22. The system of claim 19, wherein said control program attaches a header to each of said file segments.

23. The system of claim 22 wherein said file segment header comprises at least one of an offset field and a size field.

24. The system of claim 19, wherein said control program writes said files and said file segments to the then least filled-up backup device.

25. A method for file backup using a parallel backup system comprising at least one file source and at least two backup devices, the method comprising:
calculating a segmentation threshold value; and
directing said files from said file source to said backup devices.

26. The method of claim 25, wherein said backup system is distributed.

27. The method of claim 25, wherein said backup system is geographically distributed.

28. The method of claim 25, wherein said file source a storage device, a hard disk, a random access memory, a programmable non-volatile memory, a redundant array of independent disks (RAID), an incremental backup data, a snapshot data, a file system, a distributed file system or a location independent file system.

29. The method of claim 25, wherein said segmentation threshold value is calculated by summing the sizes of all files in said file source and dividing the result by the number of said backup devices.

30. The method of claim 25, wherein the method further comprises:
splitting files that exceed said segmentation threshold value into file segments, wherein each of said file segments do not exceed said segmentation threshold value;
sorting files located in said file source and said file segments into a sorted list; and
writing files smaller than said segmentation threshold value and said file segments into said backup devices according to said sorted list.

31. The method of claim 30, wherein the method further comprises attaching a header to each of said file segments.

32. The method of claim 31, wherein said file segment header comprises at least one of an offset field or a size field.

33. The method of claim 30, wherein the method further comprises sorting said files and said file segments in descending order based upon file size.

34. The method of claim 30, wherein the method further comprises sorting said files and said file segments in ascending order based upon file size.

35. The method of claim 30, wherein the method further comprises concurrently writing said files and said file segments to said backup devices.

36. The method of claim 35, wherein the method further comprises writing said files and said file segments in accordance with their ordered position in said sorted list.

37. The method of claim 30, wherein the method further comprises writing said files and said file segments to the then least filled-up backup device.

38. The method of claim 25, wherein the method further comprises:
sorting files located in said file source into a sorted list;
writing files smaller than said segmentation threshold value into said backup devices according to said sorted list;
splitting files larger than said segmentation threshold value into file segments according to space remaining in each of said backup devices; and
writing said file segments onto said backup devices.

39. The method of claim 38, wherein the method further comprises sorting said files and said file segments in descending order based upon file size.

40. The method of claim 38, wherein the method further comprises sorting said files and said file segments in ascending order based upon file size.

41. The method of claim 38, wherein the method further comprises concurrently writing said files to said backup devices.

42. The method of claim 38, wherein the method further comprises concurrently writing said file segments to said backup devices.

43. The method of claim 41, wherein the method further comprises writing said files in accordance with their ordered position in said sorted list.

44. The method of claim 38, wherein the method further comprises splitting files larger than said segmentation threshold value to file segments according to space remaining in said backup devices.

45. The method of claim 44, wherein the method further comprises attaching a header to each of said file segments.

46. The method of claim 45, wherein said file segment header comprises at least one of an offset field and a size field.

47. The method of claim 38, wherein the method further comprises writing said files and said file segments to the then least filled-up backup device.

48. A computer software product for a parallel backup system comprising at least a file source and at least two backup devices, the computer program product comprising:
software instructions for enabling said parallel backup system to perform predetermined operations, and a computer readable medium bearing the software instructions, said predetermined operations comprising:
calculating a segmentation threshold value; and
directing said files from said file source to said backup devices.

49. The computer software product of claim 48, wherein said backup system is geographically distributed.

50. The computer software product of claim 48, wherein said predetermined operations calculate said segmentation threshold value by summing the sizes of all files in said file source and dividing the result by the number of said backup devices.

51. The computer software product of claim 48, wherein said predetermined operations further comprise:
splitting files that exceed said segmentation threshold value into file segments, wherein each of said file segments do not exceed said segmentation threshold value;
sorting files located in said file source and said file segments into a sorted list; and
writing files smaller than said segmentation threshold value and said file segments into said backup devices according to said sorted list.

52. The computer software product of claim 51, wherein said predetermined operations further comprise attaching a header to each of said file segments.

53. The computer software product of claim 52, wherein said file segment header comprises at least one of an offset field and a size field.

54. The computer software product of claim 51, wherein said predetermined operations sort said files and said file segments in descending order based upon file size.

55. The computer software product of claim 51, wherein said predetermined operations sort said files and said file segments in ascending order based upon file size.

56. The computer software product of claim 51, wherein said predetermined operations further comprise concurrently writing said files and said file segments to said backup devices.

57. The computer software product of claim 51, wherein said predetermined operations further comprise writing said files and said file segments in accordance with their ordered position in said sorted list.

58. The computer software product of claim 51, wherein said predetermined operations further comprise writing said files and said file segments to the then least filled-up backup device.

59. The computer software product of claim 48, wherein the predetermined operations further comprise:
sorting files located in said file source into a sorted list;
writing files smaller than said segmentation threshold value into said backup devices according to said sorted list;
splitting files larger than said segmentation threshold value into file segments according to space remaining in each of said backup devices; and
writing said file segments onto said backup devices.

60. The computer software product of claim 59, wherein the predetermined operations further comprise sorting said files and said file segments in descending order based upon file size.

61. The computer software product of claim 59, wherein the predetermined operations further comprise sorting said files and said file segments in ascending order based upon file size.

62. The computer software product of claim 59, wherein the predetermined operations further comprise concurrently writing said files to said backup devices.

63. The computer software product of claim 59, wherein the predetermined operations further comprise concurrently writing said file segments to said backup devices.

64. The computer software product of claim 62, wherein the predetermined operations further comprise writing said files in accordance with their ordered position in said sorted list.

65. The computer software product of claim 59, wherein the predetermined operations further comprise splitting files larger than said segmentation threshold value to file segments according to space remaining in said backup devices.

66. The computer software product of claim 65, wherein the predetermined operations further comprise attaching a header to each of said file segments.

67. The computer software product of claim 66, wherein said file segment header comprises at least one of an offset field and a size field.

68. The computer software product of claim 59, wherein the predetermined operations further comprise writing said files and said file segments to the then least filled-up backup device.

69. A computer system adapted for parallel backup of at least a file source and at least two backup devices, the computer system comprising:
at least a file source and at least two backup devices interconnected by a communications link;
a memory comprising software instructions adapted to enable the computer system to perform:
calculating a segmentation threshold value; and
directing said files from said file source to said backup devices.

70. The computer system of claim 69, wherein said backup system is geographically distributed.

71. The computer system of claim 69, wherein said software instructions are further adapted to calculate said segmentation threshold value by summing the sizes of all files in said file source and dividing the result by the number of said backup devices.

72. The computer system of claim 69, wherein said software instructions are further adapted to:
split files that exceed said segmentation threshold value into file segments, wherein each of said file segments do not exceed said segmentation threshold value;
sort files located in said file source and said file segments into a sorted list; and
write files smaller than said segmentation threshold value and said file segments into said backup devices according to said sorted list.

73. The computer system of claim 72, wherein said software instructions are further adapted to attach a header to each of said file segments.

74. The computer system of claim 73, wherein said file segment header comprises at least one of an offset field and a size field.

75. The computer system of claim 72, wherein said software instructions are further adapted to sort said files and said file segments in descending order based upon file size.

76. The computer system of claim 72, wherein said software instructions are further adapted to sort said files and said file segments in ascending order based upon file size.

77. The computer system of claim 72, wherein said software instructions are further adapted to concurrently write said files and said file segments to said backup devices.

78. The computer system of claim 72, wherein said software instructions are further adapted to write said files and said file segments in accordance with their ordered position in said sorted list.

79. The computer system of claim 72, wherein said software instructions are further adapted to write said files and said file segments to the then least filled-up backup device.

80. The computer system of claim 69, wherein said software instructions are further adapted to:
sort files located in said file source into a sorted list;
write files smaller than said segmentation threshold value into said backup devices according to said sorted list;
split files larger than said segmentation threshold value into file segments according to space remaining in each of said backup devices; and
write said file segments onto said backup devices.

81. The computer system of claim 80, wherein said software instructions are further adapted to sort said files and said file segments in descending order based upon file size.

82. The computer system of claim 80, wherein said software instructions are further adapted to sort said files and said file segments in ascending order based upon file size.

83. The computer system of claim 80, wherein said software instructions are further adapted to concurrently write said files to said backup devices.

84. The computer system of claim 80, wherein said software instructions are further adapted to concurrently write said file segments to said backup devices.

85. The computer system of claim 83, wherein said software instructions are further adapted to write said files in accordance with their ordered position in said sorted list.

86. The computer system of claim 80, wherein said software instructions are further adapted to split files larger than said segmentation threshold value to file segments according to space remaining in said backup devices.

87. The computer system of claim 86, wherein said software instructions are further adapted to attach a header to each of said file segments.

88. The computer system of claim 87, wherein said file segment header comprises at least one of an offset field and a size field.

89. The computer system of claim 80, wherein said software instructions are further adapted to write said files and said file segments to the then least filled-up backup device.

90. A method for calculating a size threshold in a parallel backup system comprising at least a file source and at least two backup devices, the method comprising:
summing the sizes of all files in said file source; and
dividing the result by the number of available backup devices.

91. The method of claim 90, wherein said parallel backup system is distributed.

92. The method of claim 90, wherein said parallel backup system is geographically distributed.

93. The method of claim 90, wherein said file source a storage device, a hard disk, a random access memory, a programmable non-volatile memory, a redundant array of independent disks (RAID), an incremental backup data, a snapshot data, a file system, a distributed file system or a location independent file system.

94. The system of claim 90, wherein said file source is comprised of at least two independent file sources.
